(19) United States
(12) Patent Application Publication
(10) Pub. No.: US 2024/0095306 A1
(43) Pub. Date: Mar. 21, 2024

(54) INFORMATION PROCESSING APPARATUS AND INFORMATION PROCESSING METHOD

(71) Applicant: Kioxia Corporation, Tokyo (JP)

(72) Inventors: Osamu TORII, Minato Tokyo (JP); Shinichiro MANABE, Yokohama Kanagawa (JP)

(73) Assignee: Kioxia Corporation, Tokyo (JP)

(21) Appl. No.: 18/453,105

(22) Filed: Aug. 21, 2023

(30) Foreign Application Priority Data
Sep. 16, 2022 (JP) 2022-147965

(51) Int. Cl. G06F 17/18

(52) U.S. Cl. CPC G06F 17/18

(57) ABSTRACT

An information processing apparatus comprising processing circuitry. The processing circuitry is configured to acquire objective variables and explanatory variables which are regression analysis targets, extract a plurality of first explanatory variables having a high degree of influence on the objective variable from among the explanatory variables by sparse modeling using a first regression equation, and extract a second explanatory variable having a high degree of influence on the plurality of first explanatory variables by sparse modeling using a second regression equation.

### CROSS REFERENCE TO RELATED APPLICATIONS

This application is based upon and claims the benefit of priority from the prior Japanese Patent Application No. 2022-147965, filed on Sep. 16, 2022, the entire contents of which are incorporated herein by reference.

### FIELD

Embodiments described herein relate generally to an information processing apparatus and an information processing method.

### BACKGROUND

Sparse modeling for extracting an explanatory variable having a large degree of influence on an objective variable among a large number of explanatory variables has been known.

There may be another explanatory variable having a large degree of influence on at least a part of the explanatory variables among the plurality of extracted explanatory variables, and there is a concern that the explanatory variable having a large degree of influence on the objective variable cannot be extracted without omission in existing sparse modeling.

In addition, in a case where the explanatory variables are similar to each other, there is a concern that the explanatory variable having a large degree of influence on the objective variable cannot be appropriately extracted in the existing sparse modeling.

### BRIEF DESCRIPTION OF THE DRAWINGS

FIG. 1 is a block diagram of an information processing apparatus according to a first embodiment.

FIG. 2 is a flowchart illustrating an example of a processing operation of the information processing apparatus of FIG. 1.

FIG. 3 is a diagram schematically illustrating a result obtained by the information processing apparatus according to the first embodiment.

FIG. 4 is a diagram illustrating a first explanatory variable extracted by a first processing unit and a second explanatory variable extracted by a second processing unit 4.

FIG. 5 is a block diagram illustrating a schematic configuration of an information processing apparatus according to a comparative example.

FIG. 6A is a diagram for describing Equation (3).

FIG. 6B is a diagram for describing a second coefficient of Equation (3).

FIG. 6C is a diagram for describing XC of Equation (3).

FIG. 7 is a block diagram illustrating a schematic configuration of an information processing apparatus according to a second embodiment.

FIG. 8 is a flowchart illustrating a processing operation of the information processing apparatus according to the second embodiment.

FIG. 9 is a diagram schematically illustrating a scene in which a defect occurs in a procedure of processing a semiconductor wafer in a plurality of processes.

FIG. 10 is a diagram illustrating four types of reference images.

FIG. 11 is a diagram illustrating a first example of an objective variable and an explanatory variable that are analysis targets.

FIG. 12 illustrates an analysis result of a first example of the information processing apparatus according to the first embodiment or the second embodiment.

FIG. 13 is a diagram illustrating an example in which the information processing apparatus according to the present embodiment is applied to analysis of a relationship between a nucleotide sequence of a gene and a genetic disease.

FIG. 14 is a diagram illustrating a relationship between elements.

FIG. 15 is a diagram illustrating similar feature values.

### DETAILED DESCRIPTION

In general, according to the embodiment, an information processing apparatus comprising processing circuitry. The processing circuitry is configured to acquire objective variables and explanatory variables which are regression analysis targets, extract a plurality of first explanatory variables having a high degree of influence on the objective variable from among the explanatory variables by sparse modeling using a first regression equation, and extract a second explanatory variable having a high degree of influence on the plurality of first explanatory variables by sparse modeling using a second regression equation. Hereinafter, information processing apparatuses of the present disclosure will be described with reference to the drawings.

### First Embodiment

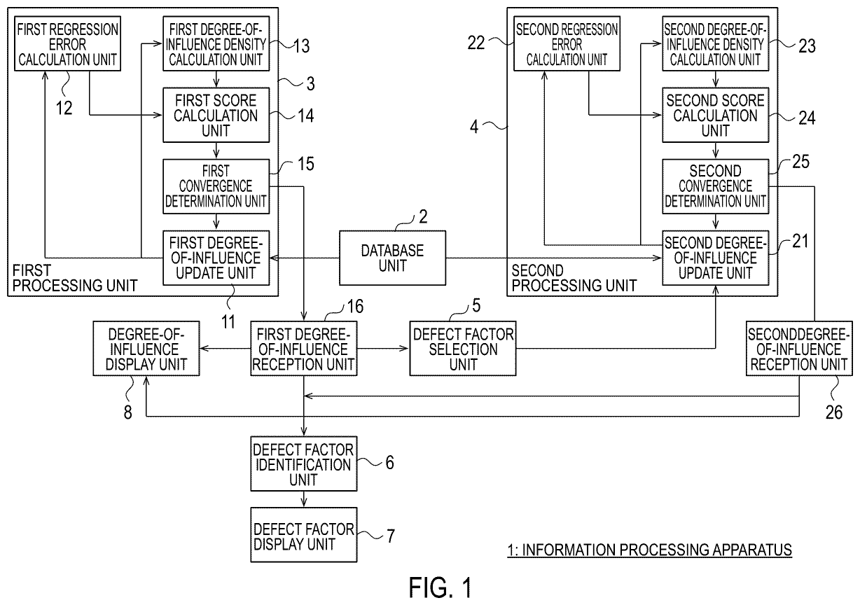

FIG. 1 is a block diagram of an information processing apparatus 1 according to a first embodiment. The information processing apparatus 1 of FIG. 1 includes a database unit 2, a first processing unit 3, and a second processing unit 4. The information processing apparatus 1 according to the present embodiment may include, for example, processing circuitry. The processing circuitry executes, for example, at least one processing operation of the database unit 2, the first processing unit 3, or the second processing unit 4 of FIG. 1.

The database unit 2 stores objective variables and explanatory variables which are regression analysis targets. The database unit 2 also serves as an acquisition unit, and the objective variable and the explanatory variable acquired from the database unit 2 are supplied to the first processing unit 3. In addition, the explanatory variable acquired from the database unit 2 is also supplied to the second processing unit 4.

Instead of the database unit 2, the regression analysis target may be monitored and a monitor image or the like may be supplied as the objective variable or the explanatory variable to the first processing unit 3 or the second processing unit 4. For example, in a case where defect analysis in a manufacturing process of a semiconductor wafer is performed, the semiconductor wafer may be captured in the manufacturing process, and the captured image may be supplied as the explanatory variable to the first processing unit 3 or the second processing unit 4, for example.

The first processing unit 3 extracts a plurality of first explanatory variables having a high degree of influence on the objective variable by sparse modeling using a first regression equation. The number of first explanatory variables extracted by the first processing unit 3 may be two or more. The plurality of first explanatory variables extracted by the first processing unit 3 are sent to the second processing unit 4.

The second processing unit 4 extracts a second explanatory variable having a high degree of influence on the plurality of first explanatory variables by sparse modeling using a second regression equation. The number of second explanatory variables extracted by the second processing unit 4 may be one or more, and there may be a plurality of second explanatory variables.

A specific method of the sparse modeling adopted by the first processing unit 3 and the second processing unit 4 is not limited to a particular method. Hereinafter, an example in which the first processing unit 3 and the second processing unit 4 use sparse modeling by multi-task Lasso will be described.

The first processing unit 3 extracts a plurality of first explanatory variables by using a first regression coefficient indicating a degree of influence on the objective variable. The second processing unit 4 calculates the second explanatory variable by using a second regression coefficient indicating a degree of influence on the plurality of first explanatory variables.

As a more specific example, the first processing unit 3 includes a first degree-of-influence update unit (first update unit) 11, a first regression error calculation unit (first calculation unit) 12, a first degree-of-influence density calculation unit (second calculation unit) 13, a first score calculation unit (third calculation unit) 14, and a first convergence determination unit (first determination unit) 15.

The first degree-of-influence update unit 11 updates the first regression coefficient indicating the degree of influence of the first explanatory variable on the objective variable based on the objective variable and the first explanatory variable.

The first regression error calculation unit 12 calculates a regression error indicating accuracy in a case where the objective variable is regressed from the first regression coefficient updated by the first degree-of-influence update unit 11 and the first explanatory variable.

The first degree-of-influence density calculation unit 13 calculates the number (density) of first regression coefficients such that the regression error calculated by the first regression error calculation unit 12 becomes small.

The first score calculation unit 14 calculates a score that is a value of the first regression equation based on a calculation result of the first degree-of-influence density calculation unit 13 and a calculation result of the first regression error calculation unit 12.

The first convergence determination unit 15 determines whether or not the score calculated by the first score calculation unit 14 satisfies a convergence condition. Since it is desirable that the score is as small as possible, the first convergence determination unit 15 may determine that the convergence condition is satisfied when the score is less than a predetermined threshold.

The first processing unit 3 repeats kinds of processing of the first degree-of-influence update unit 11, the first regression error calculation unit 12, the first degree-of-influence density calculation unit 13, and the first score calculation unit 14 until the first convergence determination unit 15 determines that the score satisfies the convergence condition.

The second processing unit 4 includes a second degree-of-influence update unit (second update unit) 21, a second regression error calculation unit (fourth calculation unit) 22, a second degree-of-influence density calculation unit 23 (fifth calculation unit), a second score calculation unit (sixth calculation unit) 24, and a second convergence determination unit 25 (second determination unit).

The second degree-of-influence update unit 21 updates the second regression coefficient indicating the degree of influence of the second explanatory variable on each of the plurality of first explanatory variables.

The second regression error calculation unit 22 calculates a regression error indicating accuracy in a case where the corresponding first explanatory variable is regressed from the second regression coefficient updated by the second degree-of-influence update unit 21 and the second explanatory variable.

The second degree-of-influence density calculation unit 23 calculates the number (density) of second regression coefficients such that the regression error calculated by the second regression error calculation unit 22 becomes small.

The second score calculation unit 24 calculates a score that is a value of the second regression equation based on a calculation result of the second degree-of-influence density calculation unit 23.

The second convergence determination unit 25 determines whether or not the score calculated by the second score calculation unit 24 satisfies a convergence condition. In the present embodiment, since it is desirable that the score is as small as possible, the second convergence determination unit 25 may determine that the convergence condition is satisfied when the score is less than a predetermined threshold.

The second processing unit 4 repeats kinds of processing of the second degree-of-influence update unit 21, the second regression error calculation unit 22, the second degree-of-influence density calculation unit 23, and the second score calculation unit 24 until the second convergence determination unit 25 determines that the score satisfies the convergence condition.

In the information processing apparatus 1 of FIG. 1, in a case where the objective variable is a defect rate and the explanatory variable is a defect factor, the information processing apparatus 1 may further include a first degree-of-influence reception unit 16, a second degree-of-influence reception unit 26, a defect factor selection unit (selection unit) 5, a defect factor identification unit 6, a defect factor display unit 7, and a degree-of-influence display unit 8. Since the objective variable is not limited to the defect rate and the explanatory variable is not limited to the defect factor, the defect factor selection unit 5 can be generalized as an explanatory variable selection unit, the defect factor identification unit 6 can be generalized as an explanatory variable identification unit, and the defect factor display unit 7 can be generalized as an explanatory variable display unit. However, in the present specification, an example in which the objective variable is the defect rate and the explanatory variable is the defect factor will be mainly described.

The first degree-of-influence reception unit 16 receives the plurality of first regression coefficients (degrees of influence) corresponding to the plurality of first explanatory variables extracted by the first processing unit 3. The second degree-of-influence reception unit 26 receives the second regression coefficient (degree of influence) corresponding to the second explanatory variable extracted by the second processing unit 4. The defect factor selection unit 5 sequentially selects the plurality of first regression coefficients corresponding to the plurality of first explanatory variables extracted by the first processing unit 3, and supplies the plurality of first regression coefficients to the second degree-of-influence update unit 21 in the second processing unit 4.

The defect factor identification unit 6 identifies, as defect factors, the plurality of first explanatory variables extracted by the first processing unit 3 and the second explanatory variables extracted by the second processing unit 4. The defect factor display unit 7 displays the defect factor identified by the defect factor identification unit 6 on a display unit of a display device (not illustrated) or various electronic devices. The electronic device is a PC, a tablet, a smartphone, or the like. The degree-of-influence display unit 8 displays a plurality of degrees of influence corresponding to the plurality of first explanatory variables and degrees of influence corresponding to the second explanatory variables on the display unit of the display device or the electronic device. The defect factor display unit 7 and the degree-of-influence display unit 8 may display the defect factor and the degrees of influence on the display unit of the identical display device or electronic device.

For example, the first processing unit 3 calculates a first regression coefficient β that minimizes a score of the first regression equation represented in the following Equation (1), and calculates components of a plurality of first explanatory variables X corresponding to components of the large first regression coefficient β. Specifically, the components (indices) I=(i1, i2, . . . ) of the plurality of first explanatory variables X are obtained.

$$L ( β ) = \frac{1}{2 n} {‖ X β - y ‖}_{2}^{2} + λ {‖ β ‖}_{1} \qquad ( 1 )$$

A first term on a right side of Equation (1) is a norm of a difference between a value obtained by multiplying the first explanatory variable X by the first regression coefficient β and the objective variable Y, and more specifically, a value obtained by averaging the sum of squares of the above-described difference is calculated. A second term on the right side is a regularization term obtained by multiplying a norm of the first regression coefficient β by a first regularization coefficient λ.

For i∈I, the second processing unit 4 sets components other than an update target component (hereinafter, component i) among the plurality of first explanatory variables X as X′, obtains a second regression coefficient β′ that minimizes a second regression equation L′(β) represented in the following Equation (2), and obtains components (indices) Ii=(ji, 1, ji, 2, . . . ) of the second explanatory variable X′ corresponding to the component of the large second regression coefficient β′.

$${L}^{′} ( {β}^{′} ) = \frac{1}{2 n} {‖ {X}^{′} {β}^{′} - {x}_{i} ‖}_{2}^{2} + {λ}^{′} {‖ {β}^{′} ‖}_{1} \qquad ( 2 )$$

A first term on a right side of Equation (2) is a norm of a difference between a value obtained by multiplying the second explanatory variable X′ by the second regression coefficient β′ and a first explanatory variable Xi, and more specifically, is a value obtained by averaging the sum of squares of the above-described difference. A second term on the right side is a normalization term obtained by multiplying a norm of the second regression coefficient β′ by a second regularization coefficient λ′.

The information processing apparatus 1 of FIG. 1 outputs the plurality of first explanatory variables I calculated by Equation (1) and the second explanatory variable Ii calculated by Equation (2).

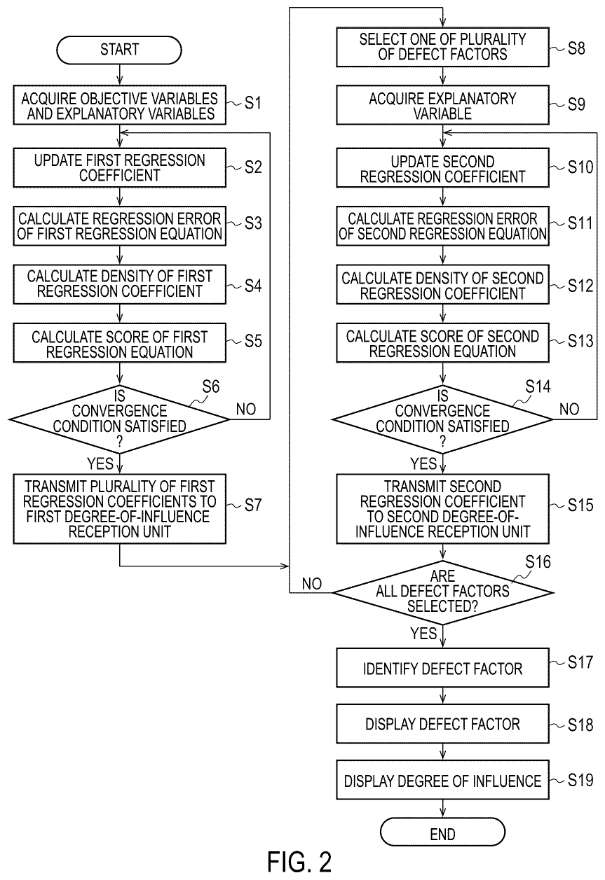

FIG. 2 is a flowchart illustrating an example of a processing operation of the information processing apparatus 1 of FIG. 1. Steps S1 to S7 of FIG. 2 indicate processing operations of the first processing unit 3, steps S8 to S16 indicate processing operations of the second processing unit 4, and steps S17 to S19 indicate processing operations of the defect factor identification unit 6, the defect factor display unit 7, and the degree-of-influence display unit 8.

First, the first processing unit 3 reads out the objective variable and the explanatory variable registered in the database unit 2 (step S1). In step S1, a larger number of explanatory variables than the plurality of first explanatory variables finally extracted by the first processing unit 3 are read out.

The first degree-of-influence update unit 11 updates the first regression coefficient indicating the degree of influence of the explanatory variable on the objective variable based on the objective variable and the explanatory variable read out in step S1 (step S2).

Subsequently, the first regression error calculation unit 12 calculates the regression error indicating the accuracy in a case where the objective variable is regressed from the first regression coefficient updated in step S2 and the explanatory variable (step S3). Subsequently, the first degree-of-influence density calculation unit 13 calculates the number (density) of first regression coefficients such that the regression error calculated in step S3 becomes small (step S4). By the processing of step S4, the number of the plurality of extracted first explanatory variables and the number of corresponding first regression coefficients are adjusted.

Subsequently, the first score calculation unit 14 calculates the score of the first regression equation based on the calculation result of step S4 (step S5). Subsequently, the first convergence determination unit 15 determines whether or not the score satisfies a predetermined convergence condition (step S6). Since a smaller score is generally more desirable, the convergence condition is set to, for example, an upper limit of an acceptable score.

When it is determined in step S6 that the score does not satisfy the convergence condition, the kinds of processing of steps S2 to S6 are repeated. When it is determined in step S6 that the score satisfies the convergence condition, a plurality of first regression coefficients corresponding to the extracted plurality of first explanatory variables are sent to the first degree-of-influence reception unit 16 (step S7). The plurality of extracted first explanatory variables correspond to a plurality of defect factors.

The defect factor selection unit 5 sequentially selects one of the plurality of first regression coefficients corresponding to the plurality of defect factors (step S8). That is, in step S8, selection is performed for each defect factor. Subsequently, the corresponding explanatory variable (second explanatory variable) is acquired from the database unit 2 (step S9).

The kinds of subsequent processing in steps S10 to S15 are performed for each first regression coefficient corresponding to the defect factor selected in step S8. First, the second degree-of-influence update unit 21 updates a first coefficient and a second coefficient indicating the degree of influence of the second explanatory variable on the selected first explanatory variable (step S10). The first coefficient is a regression coefficient of the second regression equation, and the second coefficient is a coefficient indicating a multicollinearity relationship. The first coefficient corresponds to the second regression coefficient β′ of Equation (2), and the second coefficient corresponds to the second regularization coefficient λ′ of Equation (2). In the present specification, the first coefficient and the second coefficient correspond to the second regression coefficient.

Subsequently, the second regression error calculation unit 22 calculates a regression error indicating the accuracy in a case where the selected first explanatory variable is regressed from the second regression coefficient updated in step S10 and the second explanatory variable (step S11). Subsequently, the second degree-of-influence density calculation unit 23 calculates the number (density) of second coefficients such that the regression error calculated in step S11 becomes small (step S12).

Subsequently, the second score calculation unit 24 calculates the score of the second regression equation based on the calculation result of step S12 (step S13). Subsequently, the second convergence determination unit 25 determines whether or not the score satisfies a predetermined convergence condition (step S14).

When it is determined in step S14 that the score does not satisfy the convergence condition, the kinds of processing of steps S10 to S14 are repeated. When it is determined in step S14 that the score satisfies the convergence condition, the extracted second explanatory variable is transmitted to the second degree-of-influence reception unit 26 (step S15).

When the kinds of processing of steps S10 to S15 are completed for the plurality of defect factors, it is determined whether or not the kinds of processing of steps S10 to S15 are performed for all the defect factors (step S16). When there remains a defect factor that has not yet been processed, the kinds of processing of steps S8 to S16 are repeated.

When the kinds of processing of steps S10 to S15 are completed for all the defect factors, the defect factor identification unit 6 identifies, as defect factors, the plurality of first explanatory variables obtained in the processing of the first processing unit 3 (steps S2 to S7) and the second explanatory variable obtained in the processing of the second processing unit 4 (steps S10 to S15) (step S17).

Subsequently, the defect factor display unit 7 displays the defect factor identified in step S15 (step S18). In addition, the degree-of-influence display unit 8 displays the degrees of influence respectively corresponding to the plurality of first explanatory variables and the second explanatory variables corresponding to the defect factors (step S19).

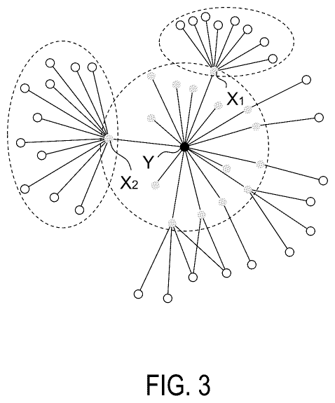

FIG. 3 is a diagram schematically illustrating a result obtained by the information processing apparatus 1 according to the first embodiment. The objective variable Y is arranged at a center of FIG. 3. The first processing unit 3 extracts a plurality of first explanatory variables (some gray circles connected to the objective variable Y in FIG. 3 by a solid line) X₁ and X₂ having a high degree of influence on the objective variable Y indicated by a black circle. The second processing unit 4 extracts a second explanatory variable having a high degree of influence on the plurality of first explanatory variables (white circles connected to the first explanatory variables in FIG. 3 by solid lines).

Consequently, according to the first embodiment, not only the plurality of first explanatory variables having the high degree of influence on the objective variable Y can be extracted, but also the second explanatory variable having the high degree of influence on each of the first explanatory variables can be extracted, and all the explanatory variables having the high degree of influence on the objective variable Y can be extracted without omission.

Although the second processing unit 4 alone does not have a high degree of influence on the objective variable Y, the second processing unit can also extract a second explanatory variable having a high degree of influence on the first explanatory variable by combining the plurality of the second explanatory variables.

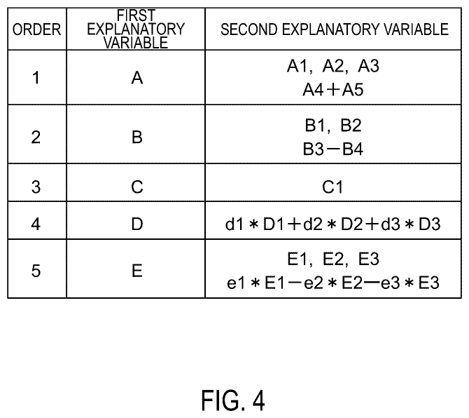

FIG. 4 is a diagram illustrating the first explanatory variable extracted by the first processing unit 3 and the second explanatory variable extracted by the second processing unit 4. For example, in order 1, the first processing unit 3 extracts a first explanatory variable A, and the second processing unit 4 extracts second explanatory variables A1, A2, A3, and A4+A5. Each of A4 and A5 alone does not have a high degree of influence on the first explanatory variable A, but a combination of A4 and A5 increases a degree of influence on the first explanatory variable A.

Specific examples in which the degree of influence on the first explanatory variable is increased by combining the plurality of second explanatory variables include, in addition to an example in which the plurality of second explanatory variables are added (order 1), an example in which the plurality of second explanatory variables are subtracted (order 2), an example in which a product-sum calculation of the plurality of second explanatory variables is performed (order 4), and an example in which a product-difference calculation of the plurality of second explanatory variables is performed (order 5).

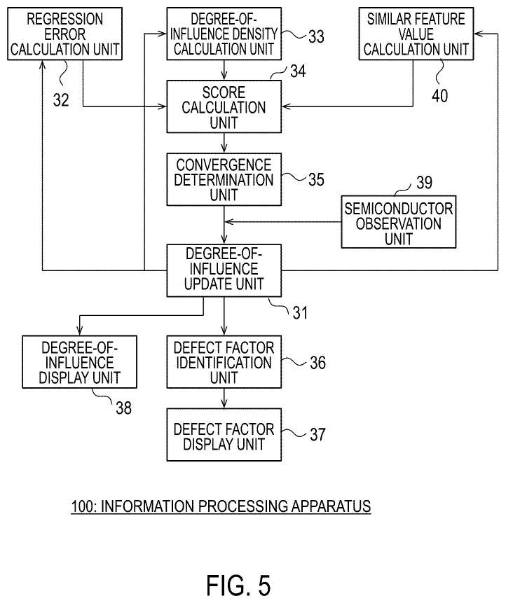

FIG. 5 is a block diagram illustrating a schematic configuration of an information processing apparatus 100 according to a comparative example. The information processing apparatus 100 of FIG. 5 illustrates a block configuration intended to analyze a defect factor in a manufacturing process of a semiconductor device.

The information processing apparatus 100 of FIG. 5 includes a degree-of-influence update unit 31, a regression error calculation unit 32, a degree-of-influence density calculation unit 33, a score calculation unit 34, a convergence determination unit 35, a defect factor identification unit 36, a defect factor display unit 37, a degree-of-influence display unit 38, a semiconductor observation unit 39, and a similar feature value calculation unit 40.

Since each block other than the semiconductor observation unit 39 and the similar feature value calculation unit 40 performs processing similar to the block having the identical name of FIG. 1, the description thereof will be omitted. The semiconductor observation unit 39 is provided instead of the database unit 2 of FIG. 1, and inputs an objective variable and an explanatory variable related to defect analysis of a semiconductor wafer to be analyzed.

The similar feature value calculation unit 40 calculates a similar feature value similar to a feature value of the explanatory variable, and extracts an explanatory variable similar to the explanatory variable.

Since the information processing apparatus 100 according to the comparative example illustrated in FIG. 5 includes the similar feature value calculation unit 40, it is possible to extract an explanatory variable similar to an explanatory variable having a high degree of influence on the objective variable. However, since regression analysis is not performed in two stages, it is not possible to extract a second explanatory variable having a high degree of influence on each of a plurality of first explanatory variables having a high degree of influence on the objective variable. Thus, the information processing apparatus 100 of FIG. 5 cannot extract the second explanatory variable illustrated in FIG. 3 or 4.

As described above, in the first embodiment, after the sparse modeling for extracting the plurality of first explanatory variables having a high degree of influence on the objective variable is performed, since the sparse modeling for extracting the second explanatory variable having a high degree of influence on the plurality of first explanatory variables is performed, the explanatory variables having a high degree of influence on the objective variable can be extracted substantially without omission.

### Second Embodiment

In the first embodiment, since sparse modeling using two types of regression equations is performed, there is a concern that it takes time to obtain a regression analysis result. In a second embodiment to be described below, a regression analysis result is obtained by one regression analysis.

A regression equation used by an information processing apparatus 1a according to the second embodiment includes a term related to an explanatory variable having a multicollinearity relationship, as represented in Equation (3). λ, λ2, and λ3 in Equation (3) are regularization coefficients.

$$L ( β ) = \frac{1}{2 n} {‖ X β - y ‖}_{2}^{2} + λ {‖ β ‖}_{1} + λ 2 ‖ XC ‖ + λ 3 ‖ C ‖ \qquad ( 3 )$$

A first term on a right side of Equation (3) is a norm of a difference between a value obtained by multiplying the first explanatory variable X by the first coefficient β and the objective variable Y, and more specifically, corresponds to a value obtained by averaging the sum of squares of the above-described difference. A second term on the right side is a value obtained by multiplying a norm of the first coefficient β by the first regularization coefficient λ, and more specifically, is a sum of absolute values of values obtained by multiplying the norm of the first coefficient β by the first regularization coefficient λ. A third term on the right side is an absolute value of a value obtained by multiplying a norm of a value obtained by multiplying the second explanatory variable X by a second coefficient C by a second regularization coefficient λ2. A fourth term on the right side is an absolute value of a value obtained by multiplying a norm of the second coefficient C by a third regularization coefficient λ3.

The multicollinearity means a case where there is a plurality of collinearity having a linear relationship (primary dependency) between the explanatory variables. When there are a plurality of explanatory variables having a multicollinearity relationship, there is a concern that the explanatory variable having a high degree of influence on the objective variable cannot be appropriately extracted. Therefore, in Equation (3), regularization terms (the third term and the fourth term on the right side) related to multicollinearity are provided, and sparse modeling is performed in consideration of explanatory variables having a multicollinearity relationship.

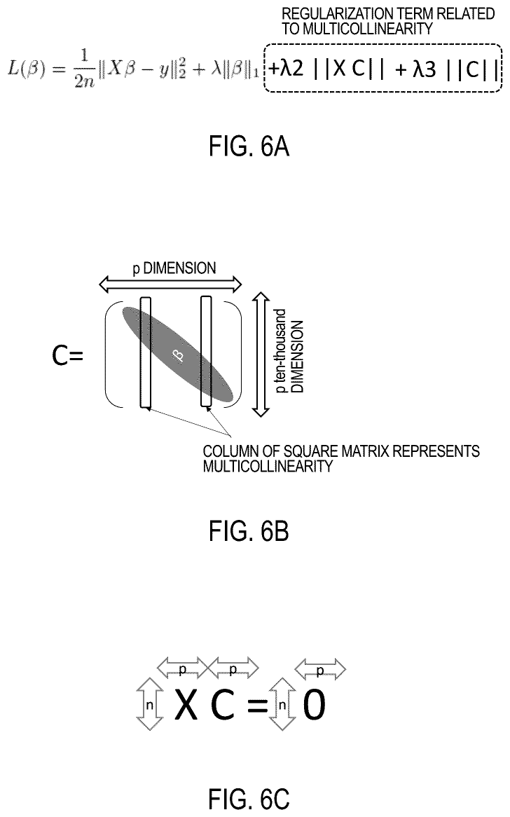

FIGS. 6A, 6B, and 6C are diagrams for describing Equation (3). As illustrated in FIG. 6A, the third term and the fourth term on the right side of Equation (3) are regularization terms related to multicollinearity. The value of the regularization term is desirably as small as possible.

In the present specification, β of Equation (3) is referred to as the first coefficient, and C is referred to as the second coefficient. The first coefficient β is the regression coefficient. The second coefficient C is a coefficient indicating a multicollinearity relationship, and is a coefficient indicated by, for example, a p-dimensional×p-dimensional square matrix as illustrated in FIG. 6B. Each column of C indicates multicollinearity. Since the value of the second coefficient C is related to the first coefficient β, the first coefficient β is also obtained by obtaining the second coefficient C of the regularization term such that the score of Equation (3) is minimized. The fourth term of Equation (3) indicates the norm of the second coefficient C, and is desirably a value as small as possible.

As illustrated in FIG. 6C, the third term on the right side of Equation (3) is multiplication of the explanatory variable X indicated by an n-dimensional×p-dimensional matrix and the second coefficient C indicated by the p-dimensional×p-dimensional matrix illustrated in FIG. 6B, and the multiplication result is set to zero.

The information processing apparatus 1a according to the second embodiment obtains the second coefficient C such that the third term on the right side of Equation (3) becomes zero and the fourth term on the right side becomes as small as possible.

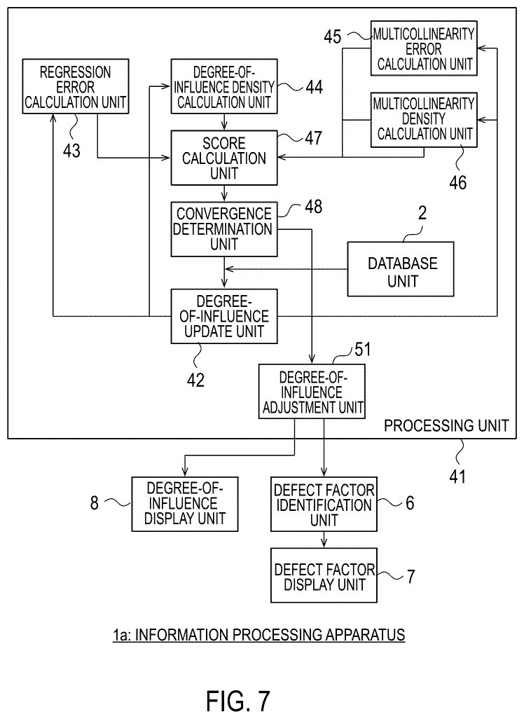

FIG. 7 is a block diagram illustrating a schematic configuration of the information processing apparatus 1a according to the second embodiment. The information processing apparatus 1a of FIG. 7 includes a database unit (acquisition unit) 2 and a processing unit 41. The database unit 2 of FIG. 7 is similar to the database unit 2 of FIG. 1. The database unit 2 may be arranged outside the processing unit 41. The processing unit 41 extracts a plurality of first explanatory variables having a high degree of influence on the objective variable by spark modeling using a predetermined regression equation, and extracts a second explanatory variable having a high degree of influence on the plurality of first explanatory variables.

The processing unit 41 of FIG. 7 includes a degree-of-influence update unit (update unit) 42, a regression error calculation unit (first calculation unit) 43, a degree-of-influence density calculation unit (second calculation unit) 44, a multicollinearity error calculation unit (third calculation unit) 45, a multicollinearity density calculation unit (fourth calculation unit) 46, a score calculation unit 47, and a convergence determination unit (determination unit) 48.

The degree-of-influence update unit 42 updates a regression coefficient indicating the degree of influence of the first explanatory variable on the objective variable based on the first explanatory variable extracted from the explanatory variable and the objective variable.

The regression error calculation unit 43 calculates a regression error indicating a regression error in a case where the objective variable is regressed from the regression coefficient updated by the degree-of-influence update unit 42 and the first explanatory variable.

The degree-of-influence density calculation unit 44 calculates the number (density) of regression coefficients such that the regression error calculated by the regression error calculation unit 43 becomes small.

The multicollinearity error calculation unit 45 calculates an error of multicollinearity from the second explanatory variable and the second coefficient. More specifically, the multicollinearity error calculation unit 45 obtains the second explanatory variable and the second coefficient C in the third term on the right side of Equation (3) such that the score of the regression equation is minimized.

The multicollinearity density calculation unit 46 calculates the number (density) of second coefficients. More specifically, the multicollinearity density calculation unit 46 obtains the second coefficient C of the fourth term on the right side of Equation (3) such that the score of the regression equation is minimized.

As described above, since the second coefficient C is a value related to the first coefficient β, not only the second coefficient C but also the first coefficient β is obtained by performing the kinds of processing of the multicollinearity error calculation unit 45 and the multicollinearity density calculation unit 46.

The score calculation unit 47 calculates the score of the regression equation represented in Equation (3) based on the calculation result of the multicollinearity density calculation unit 46.

The convergence determination unit 48 determines whether or not the score obtained by the score calculation unit 47 satisfies a convergence condition. Since it is desirable that the score is as small as possible, the convergence determination unit 48 may determine that the convergence condition is satisfied when the score is less than a predetermined threshold.

The processing unit 41 of FIG. 7 may include a degree-of-influence adjustment unit 51. In a case where the number of first coefficients 13 and second coefficients C extracted by performing the kinds of processing of the multicollinearity error calculation unit 45 and the multicollinearity density calculation unit 46 is too large, the degree-of-influence adjustment unit 51 performs processing of adjusting the number to an appropriate number.

In addition, the information processing apparatus 1a of FIG. 7 may include a defect factor identification unit 6, a defect factor display unit 7, and a degree-of-influence display unit 8.

The defect factor identification unit 6 identifies, as defect factors, the first explanatory variable and the second explanatory variable corresponding to the first coefficient β and the second coefficient C adjusted by the degree-of-influence adjustment unit 51. Processing operations of the defect factor display unit 7 and the degree-of-influence display unit 8 are similar to the processing operations of FIG. 1.

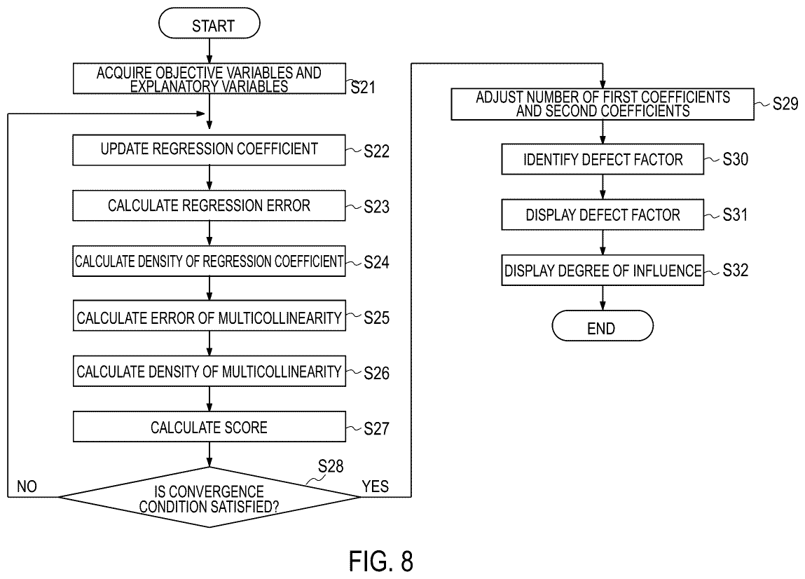

FIG. 8 is a flowchart illustrating a processing operation of the information processing apparatus 1a according to the second embodiment. First, the processing unit 41 acquires the objective variable and the explanatory variable from the database unit 2 (step S21). In a case where the analysis target is a semiconductor wafer in a semiconductor manufacturing process, the objective variable and the explanatory variable may be acquired from the semiconductor observation unit or the like instead of the database unit 2.

Subsequently, the degree-of-influence update unit 42 updates the regression coefficient indicating the degree of influence of the first explanatory variable on the objective variable based on the first explanatory variable extracted from the explanatory variable and the objective variable (step S22).

Subsequently, the regression error calculation unit 43 calculates a regression error indicating the accuracy in a case where the objective variable is regressed from the regression coefficient updated by the degree-of-influence update unit 42 and the first explanatory variable (step S23).

Subsequently, the degree-of-influence density calculation unit 44 calculates the number (density) of regression coefficients such that the regression error calculated by the regression error calculation unit 43 becomes small (step S24).

Subsequently, the multicollinearity error calculation unit 45 calculates an error of multicollinearity from the second explanatory variable and the second coefficient (step S25). More specifically, the multicollinearity error calculation unit 45 obtains the second explanatory variable and the second coefficient C in the third term on the right side of Equation (3) such that the score of the regression equation is minimized.

Subsequently, the multicollinearity density calculation unit 46 calculates the number (density) of second coefficients (step S26). More specifically, the multicollinearity density calculation unit 46 obtains the second coefficient C of the fourth term on the right side of Equation (3) such that the score of the regression equation is minimized.

Subsequently, the score calculation unit 47 calculates the score of the regression equation represented in Equation (3) based on the calculation result of the multicollinearity density calculation unit 46 (step S27).

Subsequently, the convergence determination unit 48 determines whether or not the score obtained by the score calculation unit 47 satisfies a convergence condition (step S28). When it is determined that the score does not satisfy the convergence condition, the kinds of processing of steps S22 to S28 are repeated. When it is determined that the score satisfies the convergence condition, the degree-of-influence adjustment unit 51 performs processing of adjusting the number of first coefficients 13 and second coefficients C to an appropriate number in a case where the number of first coefficients 13 and second coefficients C extracted by performing the kinds of processing of the multicollinearity error calculation unit 45 and the multicollinearity density calculation unit 46 described above are too large (step S29).

Subsequently, the defect factor identification unit 6 identifies, as defect factors, the first explanatory variable and the second explanatory variable corresponding to the first coefficient β and the second coefficient C adjusted by the degree-of-influence adjustment unit 51 (step S30).

Subsequently, the defect factor display unit 7 displays the defect factor (step S31). In addition, the degree-of-influence display unit 8 displays the degree of influence including the first coefficient β and the second coefficient C (step S32).

As described above, in the second embodiment, the plurality of first explanatory variables having a high degree of influence on the objective variable and the second explanatory variables having a high degree of influence on the plurality of first explanatory variables can be extracted by sparse modeling in one stage. Thus, as compared with the first embodiment in which the sparse modeling is performed in two stages, the processing operation of the information processing apparatus 1a can be simplified, and the explanatory variable can be extracted more quickly.

In addition, in the second embodiment, since the regression equation used for sparse modeling includes a penalty term (regularization term) for the explanatory variable having the multicollinearity relationship, it is possible to quickly extract a desired explanatory variable without being influenced by the explanatory variable having the multicollinearity relationship.

### Third Embodiment

The use of the information processing apparatuses 1 and 1a according to the first and second embodiments described above is not limited, but can be used, for example, for defect analysis in the manufacturing process of the semiconductor device. The semiconductor device is manufactured by performing a large number of processes such as film formation, exposure, and etching on a semiconductor wafer. There is a concern that a defect occurs during the processing of any process, and it is possible to identify a factor of the defect and take measures against the defect by analyzing what kind of defect has occurred in which process. Thus, yield is improved.

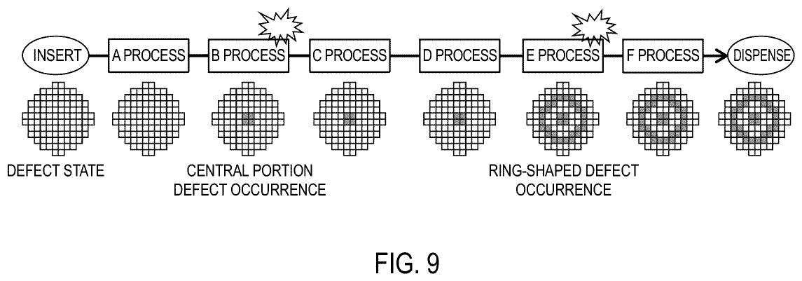

FIG. 9 is a diagram schematically illustrating a scene in which a defect occurs in a procedure of processing a semiconductor wafer in a plurality of processes. FIG. 9 illustrates an example in which the processed semiconductor wafer is dispensed through a total of six processes from A process to F process on the semiconductor wafer loaded into a semiconductor manufacturing apparatus. FIG. 9 illustrates an example in which a defect occurs in a central portion of the semiconductor wafer in B process and a ring-shaped defect further occurs in E process.

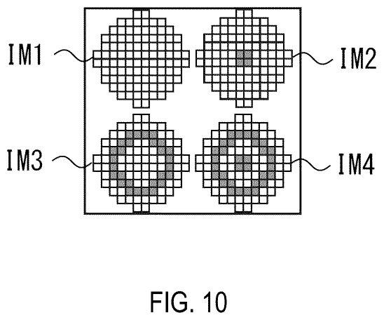

The semiconductor wafer can be classified into four types of reference images as illustrated in FIG. 10 by visualizing an electrical characteristic value or some measured value of the semiconductor wafer as an objective variable. A reference image IM1 is an image without a defect, a reference image IM2 is an image including only a defect in a central portion, a reference image IM3 is an image including only a ring-shaped defect, and a reference image IM4 is an image including both the central portion and the ring-shaped defect. In the four types of reference images illustrated in FIG. 10, a chip having a high or low measured value is expressed by a color or a luminance change by regarding a case where the measured value is higher or lower than other chips as a defect.

In a case where the defect analysis of the semiconductor wafer is performed, it is conceivable to detect, by image analysis, which of the reference images IM1 to IM4 corresponds to an image obtained by visualizing, as the objective variable, an electrical characteristic value, a measured value, or the like of the semiconductor wafer to be subjected to defect analysis. However, the identical semiconductor wafer may include defects of a plurality of different forms. In a case where a combination of a plurality of different defects is taken into consideration when the number of defect forms increases, the number of reference images becomes very large, and it takes a lot of time to classify the image to be subjected to defect analysis. In addition, in a case where a defect occurrence rate is greatly different for each defect form, there is a concern that a true cause of the defect is not accurately determined for a defect form having a low defect occurrence rate.

In contrast, since the plurality of first explanatory variables having a high degree of influence on the objective variable and the second explanatory variables having a high degree of influence on the plurality of first explanatory variables can be quickly and accurately extracted by performing the sparse modeling by Equation (1) and Equation (2) or the sparse modeling by Equation (3) described above, the true cause of the defect can be accurately determined.

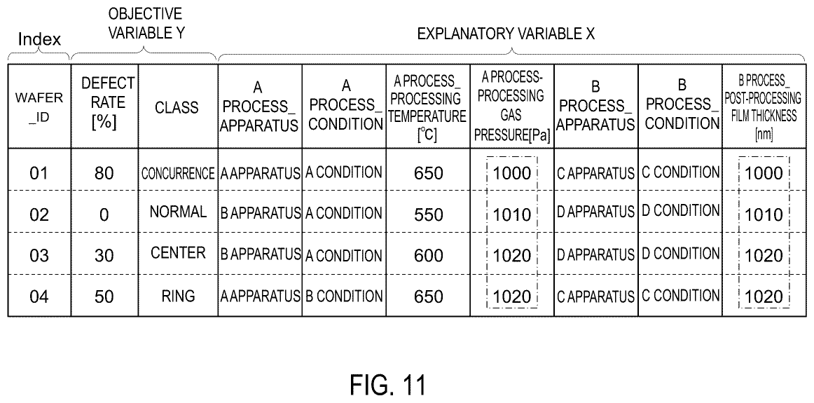

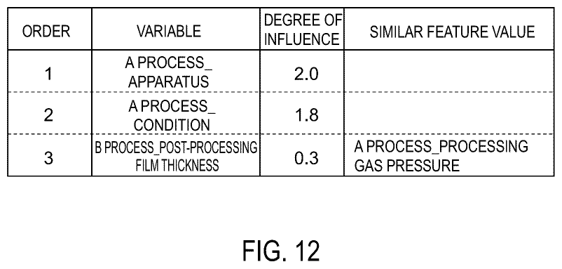

FIG. 11 is a diagram illustrating a first example of the objective variable and the explanatory variable to be analyzed, and FIG. 12 is a diagram illustrating an analysis result of a first example of the information processing apparatus 1 or 1a according to the first embodiment or the second embodiment. As illustrated in FIG. 11, a data set including an index (identification number), an objective variable Y, and an explanatory variable X is registered in the database unit 2. Alternatively, each piece of information of FIG. 11 may be input from the semiconductor observation unit (not illustrated) or the like. In the example of FIG. 11, the objective variable Y includes a defect rate and a class. The class indicates, for example, a type of defect. The defect rate indicates a defect rate of each class. The explanatory variable X includes information such as an apparatus name, a manufacturing condition, a processing temperature, and a processing gas pressure for each process. Among the explanatory variables in FIG. 11, the apparatus name and the manufacturing condition of each process are categorical variables including non-numerical data. The processing temperature and the processing gas pressure in each process are continuous variables including numerical data.

FIG. 11 illustrates an example in which, among the explanatory variables, A process_processing gas pressure and B process_post-processing film thickness are identical. In this case, in normal statistical analysis, both explanatory variables cannot be distinguished. In sparse modeling, only one of two explanatory variables is selected to obtain a smaller number of explanatory variables. Even though A process_processing gas pressure is important, B process_post-processing film thickness can be extracted. As the total number of explanatory variables increases, the number of similar explanatory variables increases by chance, and a case where a desired explanatory variable is not extracted easily occurs.

According to the first embodiment or the second embodiment, as illustrated in FIG. 12, even though B process_post-processing film thickness is extracted as the explanatory variable, the explanatory variable of A process_processing gas pressure can be extracted as the similar feature value.

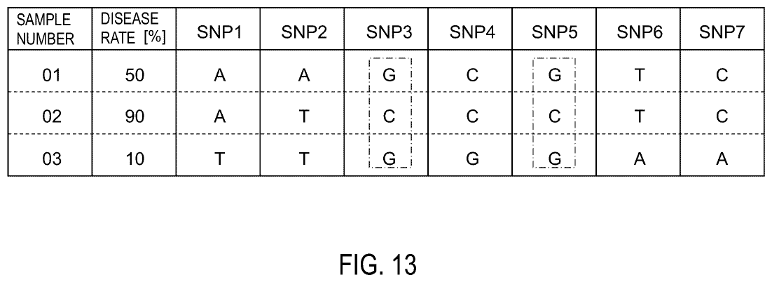

In FIGS. 10 to 12, an example in which the information processing apparatus 1 or 1a according to the first embodiment or the second embodiment is applied to analysis of a manufacturing defect of the semiconductor device has been described, but the information processing apparatus 1 or 1a according to the first embodiment or the second embodiment can be applied to analysis of various kinds of data. FIG. 13 is a diagram illustrating an example in which the information processing apparatus 1 or 1a according to the first embodiment or the second embodiment is applied to analysis of a relationship between a nucleotide sequence of a gene and a genetic disease. FIG. 13 illustrates single nucleotide polymorphism (SNP) mutations. In FIG. 13, mutations of SNP1 to SNP7 are associated with a disease rate for each individual specimen. SNP1 to SNP7 of a sample to be analyzed is input to the information processing apparatus 1 or 1a according to the first embodiment or the second embodiment, and thus, the disease rate can be accurately predicted.

FIG. 13 illustrates an example in which SNP3 and SNP5 are coincidently matched. In this case, SNP3 and SNP5 cannot be distinguished from each other in statistical analysis. Even though a more important explanatory variable is SNP3, SNP5 can be extracted. However, according to the first embodiment or the second embodiment, even though SNP5 is extracted, SNP3 can also be extracted as a similar feature value of SNP5.

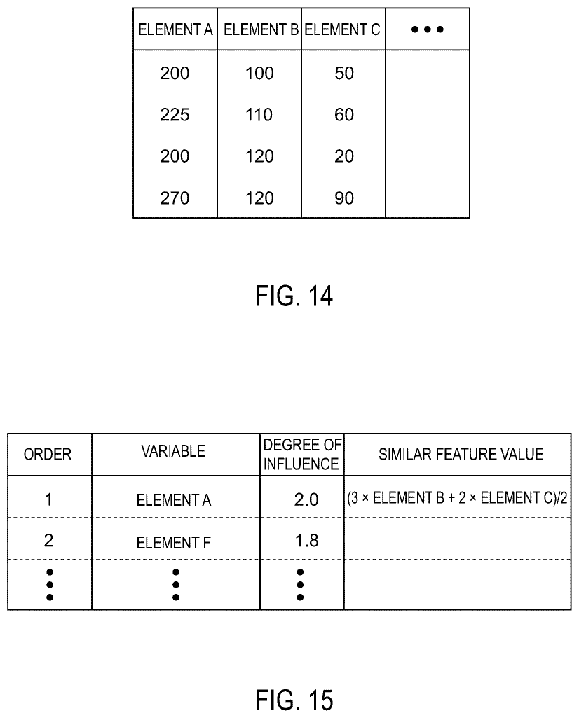

In addition, as illustrated in FIG. 14, the degree of influence on the objective variable may be increased by combining the plurality of explanatory variables. FIG. 14 illustrates an example in which 2×element A=3×element B+2×element C may be satisfied. The elements A, B, and C are all explanatory variables. For example, 3×element B+2×element C has a high degree of influence on the objective variable. In this case, originally, the element B (=100) and the element C (=50) are to be selected, but the element A (=200) may be erroneously selected.

In contrast, in the information processing apparatus 1 or 1a according to the first or second embodiment, as illustrated in FIG. 15, even though the element A (=200) is selected, (3×element B+2×element C)/2 can be extracted as the similar feature value.

As described above, the information processing apparatus 1 according to the third embodiment can accurately extract the plurality of first explanatory variables having a high degree of influence on the objective variable and the second explanatory variables having a high degree of influence on the plurality of first explanatory variables in various fields having a large number of explanatory variables that can influence the objective variable.

At least a part of the information processing apparatuses 1 and 1a described in the above-described embodiments may be achieved by hardware or software. In a case where the at least a part thereof is achieved by software, a program that achieves at least a part of the functions of the information processing apparatuses 1 and 1a may be stored in a recording medium such as a flexible disk or a CD-ROM, and may be read and executed by a computer. The recording medium is not limited to an attachable and detachable medium such as a magnetic disk or an optical disk, and may be a fixed recording medium such as a hard disk device or a memory.

In addition, the program that achieves at least a part of the functions of the information processing apparatuses 1 and 1a may be distributed via a communication line (including wireless communication) such as the Internet. The program may be distributed via a wired line or a wireless line such as the Internet in a state of being encrypted, modulated, and compressed or in a state of being stored in the recording medium.

The above-described examples may be configured as follows.

(1) An information processing apparatus comprising processing circuitry, the processing circuitry configured to:
acquire objective variables and explanatory variables which are regression analysis targets;
extract a plurality of first explanatory variables having a high degree of influence on the objective variable from among the explanatory variables by sparse modeling using a first regression equation; and
extract a second explanatory variable having a high degree of influence on the plurality of first explanatory variables by sparse modeling using a second regression equation.
   (2) The information processing apparatus according to (1),
wherein the processing circuitry is configured to extract the plurality of first explanatory variables by using a first regression coefficient indicating a degree of influence on the objective variable, and
the processing circuitry is configured to extract the second explanatory variable by using a second regression coefficient indicating a degree of influence on the plurality of first explanatory variables.
   (3) The information processing apparatus according to (2),
wherein the processing circuitry is configured to calculate the plurality of first explanatory variables corresponding to the first regression coefficient with which a score which is a value of the first regression equation is minimized, and
the processing circuitry is configured to calculate the second explanatory variable corresponding to the second regression coefficient with which a score which is a value of the second regression equation is minimized.
   (4) The information processing apparatus according to (3),
wherein the processing circuitry is further configured to:
update the first regression coefficient based on the objective variable and the first explanatory variable,
calculate a regression error indicating accuracy in a case where the objective variable is regressed from the updated first regression coefficient and the corresponding first explanatory variable,
calculate the number of first regression coefficients such that the calculated regression error becomes small,
calculate the score that is the value of the first regression equation based on the calculated number of first regression coefficients, and
determine whether or not the calculated score satisfies a convergence condition.
   (5) The information processing apparatus according to (4),
wherein the processing circuitry is configured to repeatedly perform kinds of processing of updating the first regression coefficient, calculating the regression error, calculating the number of first regression coefficients, calculating the score, and determining whether or not the calculated score satisfies the convergence condition.
   (6) The information processing apparatus according to (4) or (5),
wherein the processing circuitry is further configured to select one of a plurality of the first regression coefficients in a case where there are the plurality of first regression coefficients when it is determined that the score satisfies the convergence condition, and
wherein the processing circuitry is configured to extract the second explanatory variable by using the second regression coefficient corresponding to the selected first regression coefficient.
   (7) The information processing apparatus according to (6),
wherein the processing circuitry is further configured to:
update the second regression coefficient indicating a degree of influence of the second explanatory variable on the plurality of first explanatory variables based on the plurality of first explanatory variables,
calculate a regression error indicating accuracy in a case where the plurality of first explanatory variables are regressed from the updated second regression coefficient and the second explanatory variable,
calculate the number of second regression coefficients such that the calculated regression error becomes small,
calculate a score which is a value of the second regression equation based on the calculated number of second regression coefficients, and
determine whether or not the calculated score satisfies a convergence condition.
   (8) The information processing apparatus according to (7),
wherein the processing circuitry repeatedly performs kinds of processing of updating the second regression coefficient, calculating the regression error, calculating the number of second regression coefficients, calculating the score, and determining whether or not the calculated score satisfies the convergence condition.
   (9) The information processing apparatus according to any one of (2) to (8),
wherein the processing circuitry is further configured to identify the extracted second explanatory variable for each of the extracted plurality of first explanatory variables.
   (10) The information processing apparatus according to (9),
wherein the objective variables include a defect rate, and
the processing circuitry is configured to identify, as a defect factor, the extracted second explanatory variable for each of the extracted plurality of first explanatory variables.
   (11) The information processing apparatus according to (10), further comprising:
a display that displays the defect factor, and at least one of the corresponding first regression coefficient and second regression coefficient.
   (12) An information processing apparatus comprising processing circuitry, the processing circuitry configured to:
acquire objective variables and explanatory variables that are regression analysis targets; and
extract a plurality of first explanatory variables having a high degree of influence on the objective variable from among the explanatory variables by sparse modeling using a regression equation, and extracts a second explanatory variable having a high degree of influence on the plurality of first explanatory variables.
   (13) The information processing apparatus according to (12),
wherein the regression equation includes a term for calculating a value corresponding to a difference between the objective variable and a multiplication value of the first explanatory variable and a first coefficient, a term for calculating a value obtained by multiplying a value corresponding to the first coefficient by a first regularization coefficient, a term for calculating a value obtained by multiplying a value corresponding to a multiplication value of the second explanatory variable and a second coefficient by a second regularization coefficient, and a term for calculating a value obtained by multiplying a value corresponding to the second coefficient by a third regularization coefficient.
   (14) The information processing apparatus according to (13),
wherein the processing circuitry is further configured to:
update the first coefficient indicating a degree of influence on the first explanatory variable on the objective variable based on the objective variable and the first explanatory variable extracted from the explanatory variables,
calculate a regression error in a case where the objective variable is regressed from the updated first coefficient and the first explanatory variable,
calculate the number of first coefficients such that the calculated regression error becomes small,
calculate an error of multicollinearity from the second explanatory variable extracted from the first explanatory variable and the second coefficient,
calculate the number of second coefficients,
calculate a score of the regression equation based on the calculated number of second coefficients, and
determine whether or not the calculated score satisfies a predetermined convergence condition, and
wherein the processing circuitry is configured to update the first coefficient based on the regression error when it is determined that the score does not satisfy the convergence condition.
   (15) The information processing apparatus according to (14),
wherein the processing circuitry is configured to repeatedly perform kinds of processing of updating the first coefficient, calculating the regression error, calculating the number of first coefficients, calculating the error of multicollinearity, calculating the number of second coefficients, calculating the score, and determining whether or not the calculated score satisfies the convergence condition.
   (16) The information processing apparatus according to (14) or (15),
wherein the processing circuitry is further configured to output the plurality of first explanatory variables corresponding to the first coefficient and the second explanatory variable corresponding to the second coefficient when it is determined that the score satisfies the convergence condition.
   (17) The information processing apparatus according to (16),
wherein the processing circuitry is further configured to adjust the number of first coefficients and second coefficients when it is determined that the score satisfies the convergence condition, and
wherein the processing circuitry is configured to output the first explanatory variable corresponding to the adjusted first coefficient and the second explanatory variable corresponding to the adjusted second coefficient.
   (18) The information processing apparatus according to (16) or (17),
wherein the objective variables include a defect rate, and
the processing circuitry is further configured to identify, as defect factors, the first explanatory variable and the second explanatory variable.
   (19) The information processing apparatus according to (18), further comprising:
a display that displays the defect factor, and at least one of the corresponding first coefficient and second coefficient.
   (20) An information processing method comprising:
acquiring objective variables and explanatory variables which are regression analysis targets;
extracting a plurality of first explanatory variables having a high degree of influence on the objective variable from among the explanatory variables by sparse modeling using a first regression equation; and
extracting a second explanatory variable having a high degree of influence on the plurality of first explanatory variables by sparse modeling using a second regression equation.

While certain embodiments have been described, these embodiments have been presented by way of example only, and are not intended to limit the scope of the inventions. Indeed, the novel devices and methods described herein may be embodied in a variety of other forms; furthermore, various omissions, substitutions and changes in the form of the embodiments described herein may be made without departing from the spirit of the inventions. The accompanying claims and their equivalents are intended to cover such forms or modification as would fall within the scope and spirit of the inventions.

1. An information processing apparatus comprising processing circuitry, the processing circuitry configured to:
acquire objective variables and explanatory variables which are regression analysis targets;
extract a plurality of first explanatory variables having a high degree of influence on the objective variable from among the explanatory variables by sparse modeling using a first regression equation; and
extract a second explanatory variable having a high degree of influence on the plurality of first explanatory variables by sparse modeling using a second regression equation.

2. The information processing apparatus according to claim 1,
wherein the processing circuitry is configured to extract the plurality of first explanatory variables by using a first regression coefficient indicating a degree of influence on the objective variable, and
the processing circuitry is configured to extract the second explanatory variable by using a second regression coefficient indicating a degree of influence on the plurality of first explanatory variables.

3. The information processing apparatus according to claim 2,
wherein the processing circuitry is configured to calculate the plurality of first explanatory variables corresponding to the first regression coefficient with which a score which is a value of the first regression equation is minimized, and
the processing circuitry is configured to calculate the second explanatory variable corresponding to the second regression coefficient with which a score which is a value of the second regression equation is minimized.

4. The information processing apparatus according to claim 3,
wherein the processing circuitry is further configured to:
update the first regression coefficient based on the objective variable and the first explanatory variable,
calculate a regression error indicating accuracy in a case where the objective variable is regressed from the updated first regression coefficient and the corresponding first explanatory variable,
calculate the number of first regression coefficients such that the calculated regression error becomes small,
calculate the score that is the value of the first regression equation based on the calculated number of first regression coefficients, and
determine whether or not the calculated score satisfies a convergence condition.

5. The information processing apparatus according to claim 4,
wherein the processing circuitry is configured to repeatedly perform kinds of processing of updating the first regression coefficient, calculating the regression error, calculating the number of first regression coefficients, calculating the score, and determining whether or not the calculated score satisfies the convergence condition.

6. The information processing apparatus according to claim 4,
wherein the processing circuitry is further configured to select one of a plurality of the first regression coefficients in a case where there are the plurality of first regression coefficients when it is determined that the score satisfies the convergence condition, and
wherein the processing circuitry is configured to extract the second explanatory variable by using the second regression coefficient corresponding to the selected first regression coefficient.

7. The information processing apparatus according to claim 6,
wherein the processing circuitry is further configured to:
update the second regression coefficient indicating a degree of influence of the second explanatory variable on the plurality of first explanatory variables based on the plurality of first explanatory variables,
calculate a regression error indicating accuracy in a case where the plurality of first explanatory variables are regressed from the updated second regression coefficient and the second explanatory variable,
calculate the number of second regression coefficients such that the calculated regression error becomes small,
calculate a score which is a value of the second regression equation based on the calculated number of second regression coefficients, and
determine whether or not the calculated score satisfies a convergence condition.

8. The information processing apparatus according to claim 7,
wherein the processing circuitry repeatedly performs kinds of processing of updating the second regression coefficient, calculating the regression error, calculating the number of second regression coefficients, calculating the score, and determining whether or not the calculated score satisfies the convergence condition.

9. The information processing apparatus according to claim 2,
wherein the processing circuitry is further configured to identify the extracted second explanatory variable for each of the extracted plurality of first explanatory variables.

10. The information processing apparatus according to claim 9,
wherein the objective variables include a defect rate, and
the processing circuitry is configured to identify, as a defect factor, the extracted second explanatory variable for each of the extracted plurality of first explanatory variables.

11. The information processing apparatus according to claim 10, further comprising:
a display that displays the defect factor, and at least one of the corresponding first regression coefficient and second regression coefficient.

12. An information processing apparatus comprising processing circuitry, the processing circuitry configured to:
acquire objective variables and explanatory variables that are regression analysis targets; and
extract a plurality of first explanatory variables having a high degree of influence on the objective variable from among the explanatory variables by sparse modeling using a regression equation, and extracts a second explanatory variable having a high degree of influence on the plurality of first explanatory variables.

13. The information processing apparatus according to claim 12,
wherein the regression equation includes a term for calculating a value corresponding to a difference between the objective variable and a multiplication value of the first explanatory variable and a first coefficient, a term for calculating a value obtained by multiplying a value corresponding to the first coefficient by a first regularization coefficient, a term for calculating a value obtained by multiplying a value corresponding to a multiplication value of the second explanatory variable and a second coefficient by a second regularization coefficient, and a term for calculating a value obtained by multiplying a value corresponding to the second coefficient by a third regularization coefficient.

14. The information processing apparatus according to claim 13,
wherein the processing circuitry is further configured to:
update the first coefficient indicating a degree of influence on the first explanatory variable on the objective variable based on the objective variable and the first explanatory variable extracted from the explanatory variables,
calculate a regression error in a case where the objective variable is regressed from the updated first coefficient and the first explanatory variable,
calculate the number of first coefficients such that the calculated regression error becomes small,
calculate an error of multicollinearity from the second explanatory variable extracted from the first explanatory variable and the second coefficient,
calculate the number of second coefficients,
calculate a score of the regression equation based on the calculated number of second coefficients, and
determine whether or not the calculated score satisfies a predetermined convergence condition, and
wherein the processing circuitry is configured to update the first coefficient based on the regression error when it is determined that the score does not satisfy the convergence condition.

15. The information processing apparatus according to claim 14,
wherein the processing circuitry is configured to repeatedly perform kinds of processing of updating the first coefficient, calculating the regression error, calculating the number of first coefficients, calculating the error of multicollinearity, calculating the number of second coefficients, calculating the score, and determining whether or not the calculated score satisfies the convergence condition.

16. The information processing apparatus according to claim 14,
wherein the processing circuitry is further configured to output the plurality of first explanatory variables corresponding to the first coefficient and the second explanatory variable corresponding to the second coefficient when it is determined that the score satisfies the convergence condition.

17. The information processing apparatus according to claim 16,
wherein the processing circuitry is further configured to adjust the number of first coefficients and second coefficients when it is determined that the score satisfies the convergence condition, and
wherein the processing circuitry is configured to output the first explanatory variable corresponding to the adjusted first coefficient and the second explanatory variable corresponding to the adjusted second coefficient.

18. The information processing apparatus according to claim 16,
wherein the objective variables include a defect rate, and
the processing circuitry is further configured to identify, as defect factors, the first explanatory variable and the second explanatory variable.

19. The information processing apparatus according to claim 18, further comprising:
a display that displays the defect factor, and at least one of the corresponding first coefficient and second coefficient.

20. An information processing method comprising:
acquiring objective variables and explanatory variables which are regression analysis targets;
extracting a plurality of first explanatory variables having a high degree of influence on the objective variable from among the explanatory variables by sparse modeling using a first regression equation; and
extracting a second explanatory variable having a high degree of influence on the plurality of first explanatory variables by sparse modeling using a second regression equation.
